(19) United States
(12) Patent Application Publication
(10) Pub. No.: US 2025/0057718 A1
(43) Pub. Date: Feb. 20, 2025

(54) ADAPTIVE LIMB AND JOINT STABILIZATION SYSTEM

(71) Applicant: Christiana Care Health System, Inc., Wilmington, DE (US)

(72) Inventors: Kristie Cudmore, Elkton, MD (US); Kerry D'Alessandro, Newark, DE (US); Jessica Dickerson, Chesapeake City, MD (US); Jonathan Meade, Newark, DE (US); Geoff Shertzer, Wilmington, DE (US)

(21) Appl. No.: 18/804,260

(22) Filed: Aug. 14, 2024

Related U.S. Application Data
(60) Provisional application No. 63/532,939, filed on Aug. 16, 2023.

(51) Int. Cl. A61H 1/02

(52) U.S. Cl. CPC A61H 1/0237; A61H 2201/165; A61H 2201/50; A61H 2201/5084

(57) ABSTRACT

A system includes exoskeleton having at least one inflatable bladder. The exoskeleton is made of fabric/flexible materials, and has flexible (deflated) and rigid (inflated) states. The system's pressurization system operates to pressurize and depressurize the bladder(s). A control system includes a sensor operable to gather data to in relation to movement of a wearer of the exoskeleton. A control module is operable to process data gathered from the sensor(s) and provide a control signal to the pressurization system to cause the pressurization system to selectively pressurize or depressurize the bladder(s) as a function of the data. The control system may be configured to inflate the bladder(s) into the rigid state to provide assistive support when sensor data indicates that the wearer is standing/walking, and to deflate the bladder(s) into the flexible state to allow the wearer to sit/lie comfortably when not standing/walking, and thus when support is not needed.

### CROSS-REFERENCE TO RELATED APPLICATION

This application claims the benefit of priority under 35 U.S.C. § 119(e) of U.S. Provisional Patent Application No. 63/532,939, filed Aug. 16, 2023, the entire disclosure of which is hereby incorporated herein by reference.

### FIELD OF THE INVENTION

The present invention relates generally to prevention of falls that may result in injuries to patients and others, and more particularly, to an adaptive limb and joint stabilization system in the nature of a wearable continuous ambulation assessment and pressurizable-bladder stabilization system that has a less-cumbersome flexible state for use when support is not needed, and a rigid state providing adequate limb/joint stabilization for fall prevention when support is needed.

### DISCUSSION OF RELATED ART

Elderly persons, patients recuperating post-surgery, and persons with various afflictions have a heightened risk of falling and sustaining injuries as a result of a fall. Hospitals, nursing homes, and other entities that care for patients are particularly interested in reducing falls, and particularly in avoiding falls while a person is in their care.

A person that is likely to have a relatively high fall-risk may be provided with a fall-prevention and/or assistive device. Examples of such devices include a cane and a walker. These devices are essentially carried/moved by the user, may be inadvertently left behind or be used inconsistently, and therefore may be unavailable when needed to prevent a fall.

Other examples of such fall-prevention and/or assistive devices include a wearable joint (e.g., knee) brace. Such braces may be inadvertently left unworn, and may be bulky, such that they are uncomfortable, conspicuous and/or otherwise undesirable, which discourages use with consistency. Additionally, the amount of time needed to put on and take off the brace device before and after moving can also be a barrier to use. Accordingly, the brace may not be worn, and thus may be unavailable to provide support, when needed to prevent a fall.

Further, these fall-prevention and/or assistive devices are all large devices with a constant rigid structure that offer the same level of support over time, no matter the user's varying need for assistive support over time. Because falls occur infrequently and the rigid structure of these devices is cumbersome, the user may consider that the inconvenience of these devices outweighs the infrequent need for them, which may lead to inconsistent use and unavailability to provide support when needed to prevent a fall.

Further, a user's need for assistance or support may vary over time, e.g., based on the amount of use needed or the state of healing in the case of an injury or surgery.

What is needed is a device that is less cumbersome and/or unintrusive most of the time, to help ensure consistent use of the device, and yet provides adequate fall prevention when needed to prevent a fall.

### SUMMARY

The present invention provides an adaptive limb and joint stabilization (e.g., knee/leg, hip, elbow/arm) system in the nature of a wearable continuous ambulation assessment and bladder stabilization system. The device has a flexible state and is thus less cumbersome and/or unintrusive most of the time as compared to rigid canes, walkers and braces, to help ensure consistent use of the device, and yet also has a rigid state provides adequate fall prevention when needed to prevent a fall (e.g., when applied for stabilization of the knee/leg, and hip). Further, the device is wearable and may be worn internal to the user's clothing, to ensure that it is available when needed, e.g., to prevent a fall. Accordingly, the present invention provides a device that addresses the barriers to using an assistive device for ambulation purposes.

Additionally, because the user's assistive/supportive needs may vary over time, the system of the present invention can, in certain embodiments, avoid injury by assessing the user's ability to effectively maintain a stable gait, e.g., in the case of hip or knee joint or leg muscle weakness, and provide a varying degree of support accordingly, to further mitigate fall risk.

In an exemplary embodiment. an adaptive leg stabilization system in accordance with the present invention includes a wearable inflatable bladder exoskeleton, a pressurization system, and a control system comprising at least one sensor for selectively inflating and/or deflating the bladder exoskeleton.

More particularly, the exoskeleton may be made of fabric/flexible materials, and has flexible (deflated) and rigid (inflated) states. The system's pressurization system operates to pressurize and depressurize the bladder(s). A control system includes a sensor operable to gather data to in relation to movement of a wearer of the exoskeleton. A control module is operable to process data gathered from the sensor(s) and provide a control signal to the pressurization system to cause the pressurization system to selectively pressurize or depressurize the bladder(s) as a function of the data. The control system may be configured to inflate the bladder(s) into the rigid state to provide assistive support when sensor data indicates that the wearer is standing/walking, and to deflate the bladder(s) into the flexible state to allow the wearer to sit/lie comfortably when not standing/walking, and thus when support is not needed. The system is therefore unintrusive most of the time, to help ensure consistent use of the device, and yet provides adequate fall prevention when needed to prevent a fall.

### BRIEF DESCRIPTION OF THE FIGURES

An understanding of the following description will be facilitated by reference to the attached drawings, in which:

FIG. 1 is a front view of an exemplary adaptive leg stabilization system in accordance with an exemplary embodiment of the present invention, showing a wearable exoskeleton integrated internally to an article of clothing;

FIG. 2 is a front view of an exemplary adaptive leg stabilization system in accordance with an exemplary embodiment of the present invention, showing a wearable exoskeleton integrated internally to an article of clothing;

FIG. 3 is a schematic diagram of the exemplary adaptive leg stabilization systems of FIGS. 1 and 2;

FIG. 4 is a flow diagram illustrating exemplary operation of an exemplary adaptive leg stabilization system to inflate the exoskeleton in accordance with the present invention;

FIG. 5 is a flow diagram illustrating exemplary operation of an exemplary adaptive leg stabilization system to deflate the exoskeleton in accordance with the present invention;

FIG. 6 is a flow diagram illustrating exemplary operation of an exemplary adaptive leg stabilization system to inflate the exoskeleton in an exemplary physical therapy workflow, in accordance with the present invention;

FIG. 7 is a perspective view of an alternative exemplary adaptive leg stabilization system in accordance with an exemplary embodiment of the present invention; and

FIGS. 8A and 8B are top views of exemplary bladder structures in accordance with the present invention.

### DETAILED DESCRIPTION

The present invention an adaptive limb and joint stabilization (e.g., knee/leg, hip, elbow/arm) system in the nature of a wearable continuous ambulation assessment and bladder stabilization system. The device has a flexible state and is thus less cumbersome and/or unintrusive most of the time as compared to rigid canes, walkers and braces, to help ensure consistent use of the device, and yet also has a rigid state that provides adequate fall prevention when needed to prevent a fall (e.g., when applied for stabilization of the knee/leg, and hip). Further, the device is wearable and may be worn internal to the user's clothing, to ensure that it is available when needed, e.g., to prevent a fall. Accordingly, the present invention provides a device that addresses the barriers to using an assistive device for ambulation purposes.

Additionally, because the user's assistive/supportive needs may vary over time, the system of the present invention can, in certain embodiments, avoid injury by assessing the user's ability to effectively maintain a stable gait, e.g., in the case of hip or knee joint or leg muscle weakness, and providing a varying degree of support accordingly, to further mitigate fall risk.

An adaptive leg stabilization system 100 in accordance with the present invention includes a wearable exoskeleton 120 including inflatable bladders 124, a pressurization (inflation/deflation) system 150, and a control system 200 comprising at least one sensor for selectively pressurizing/inflating and/or depressurizing/deflating the bladder(s) of the exoskeleton 120, as shown in FIGS. 1-3 and 7.

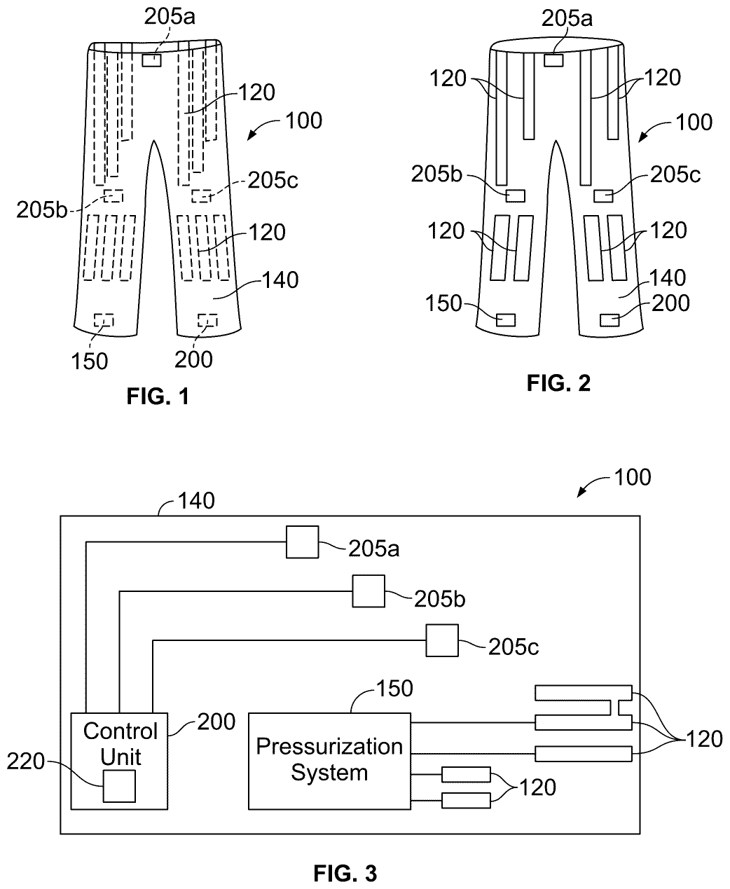

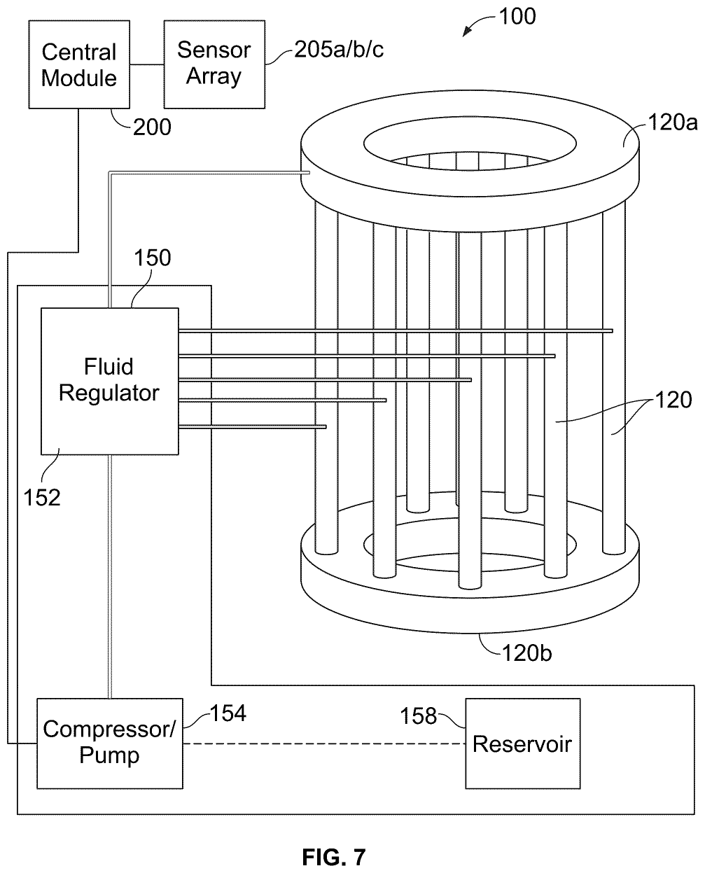

The wearable exoskeleton 120 includes at least one inflatable bladder. In an exemplary embodiment, the wearable exoskeleton 120 is integrated into a commonplace article of clothing 140, such as a pair of pants, shorts, or leggings, made of a flexible fabric, and the inflatable bladders 124 are part of and/or supported on a substrate 122, and the article of clothing acts as the substrate and is formed to mount the exoskeleton 120 to the body with the bladder(s) in registration with joints or other portions of the body as intended. The wearable exoskeleton 120 and bladders 124 may also be made of relatively flexible materials, such as durable air and/or water-tight ultralight polyester fabric with a polyurethane coating or a laminated fabric, e.g., as is commonly found in ultralight camping air mattresses. The wearable exoskeleton 120 may be integrated internally to the article of clothing (as shown in FIG. 1), e.g., in the case of pants and shorts, so that it is not plainly visible when in a flexible/deflated state. Alternatively, the wearable bladder exoskeleton 120 may be integrated externally to the article of clothing, or may not be integrated into an article of clothing, but rather may be worn over or under other articles of clothing, as shown in FIGS. 2 and 7. Accordingly, when the exoskeleton is fully deflated, or not fully inflated, the clothing 140 and exoskeleton 120 are in a flexible state in which rigidity and structural support are not provided to any great extent, and rather, the wearer can sit/lie/move unencumbered by any rigidity/inflexible that might be imparted by a comparable rigid brace, making the device very comfortable to wear on an everyday basis, and for prolonged periods of time, to promote wearing of the exoskeleton at essentially all times.

Generally, the bladder structure includes attachment points above and below the area needing support (e.g., an inflatable ring around the leg above and below the knee) and a plurality (e.g., a lattice) of inflatable chambers/tubes, etc. between these two attachment points that are inflatable to provide increased structural support as they are inflated/pressurized. The configuration of the chambers may be varied according to the nature of the support needed (for instance does the knee need lateral or linear stabilization), but the tubes/lattice generally includes a plurality of isolated bladders that are not in fluid communication with each other, so that pressure can be regulated on a per-bladder basis and the number of chambers pressurized/inflated can varied (be increased or decreased) depending upon stabilization needs in each situation. Configuration options for a plurality of bladders include a crosshatched array where chambers are isolated vertically or horizontally, or a cris-cross array where isolated chambers are interwoven in both vertically and horizontally, for example.

The pressurization system 150 may use gas (e.g., ambient air) or fluid to drive inflation/deflation, and may include, for example, a compressor or pump 154 for pressurizing air or another gas or liquid fluid, or a reservoir 158 of pressurized gas or liquid, as well as an actuator operable to open/close a valve and/or other regulator system 152 that causes pressurized gas/liquid to flow into the relevant bladder structures to make them relative rigid to provide the relevant structural support to the wearer, when needed, as best shown in FIG. 7.

The control system 200 may include one or more sensors 205a, 205b, 205c, etc. configured to gather data that can be used to selectively inflate and/or deflate the bladder(s) of the exoskeleton 120, and a control module 220 (which may include a data processor) operable to receive data from the sensors 205 and determine when to selectively pressurize and/or depressurize one or more inflatable bladders as a function of data gathered via the sensor(s), and then send one or more corresponding control signals to cause control the actuator or otherwise cause the pressurization system 150 to cause fluid to flow to selectively inflate and/or deflate one or more bladders, as determined desirable.

In one embodiment, the control system 200 may include a sensor such as an accelerometer, gyroscope, altimeter or other sensor operable to discern when a patient is stationery and/or when a patient is moving, standing and/or walking. For example, readings from multiple accelerometers spaced on the brace mid-section and extremities can be used to provide readings showing movement individually, but also in relation to each other. In certain embodiments, one or more sensors operable to discern when a patient is stationery and/or when a patient is moving, standing and/or walking may be provided directly on the device, or entirely apart from the device, e.g., such as a camera mounted on a wall of a room in which the exoskeleton is present.

Patterns of readings between the accelerometers for standing/walking versus sitting or lying down may be used to trigger an inflation or deflation of one or more bladders of the brace. The altimeter provides data points for an algorithm for detection of sudden changes in altitude of the brace that are indicative of standing, sitting, etc.

In an exemplary embodiment, the control system 200 may be configured to transmit a control signal to cause the pressurization system 150 to inflate the bladder(s) of the exoskeleton 120 when the data from the sensors 205 indicate that the patient is moving, standing and/or walking, and to cause or permit the pressurization system 150 to cause deflation of the bladder(s) of the exoskeleton 120 when data from the sensors 205 indicate that the patient is no longer moving, standing or walking.

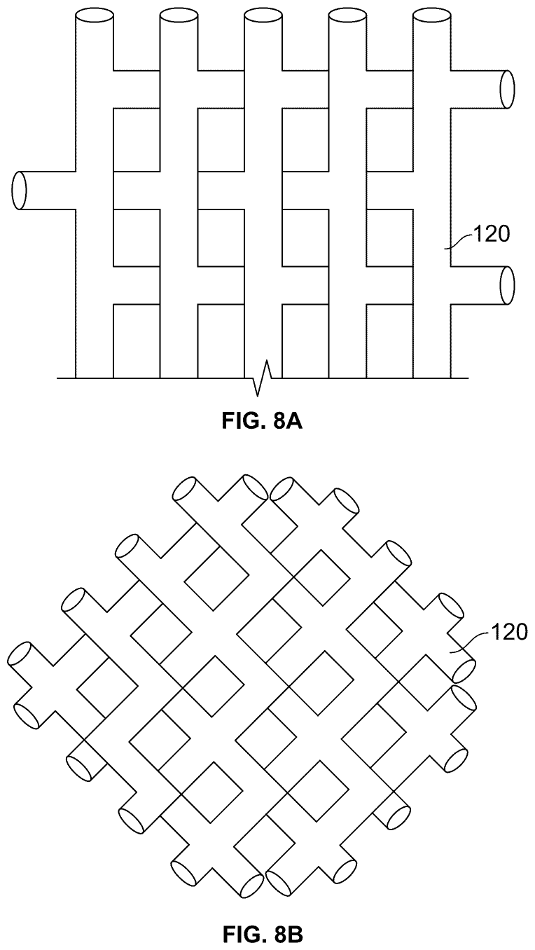

The exoskeleton 120 may be configured with one or more bladders positioned to provide two secure attachment points to the wearer's body, one above and one below the joint needing support, to secure the device to the relevant limb (for instance, inflatable cuffs 120a, 120b around the leg above and below the knee, for a brace intended to stabilize the knee joint), as best shown in FIG. 7. The bladder(s) of the exoskeleton 120 may be configured as a compartmentalized series or mesh of inflatable tubes (see FIGS. 8A, 8B) to collectively create a semi-rigid structure between the two attachment points, to allow the device to support a corresponding joint when inflated. Inflation of the attachment points and support structure between the points is driven by the compressor, pump and/or reservoir of the pressurization system 150, which are controlled by control signals from the control system 200. FIGS. 8A and 8B are examples of lattice/mesh structures that provide a structured plane with a mesh of isolated bladders that are not in fluid-communication with each other, so that they can be pressurized selectively and separately. These Figures show examples of linearly isolated bladders, represented by the dividing lines, that depend on a series of neighboring bladders to produce the overall/collectively bladder support structure. By way of further example, the lattice or mesh structure could also be of a multi-directional design, in which the bladders are interwoven at angles (e.g., 90 degrees) relative to other, and provide both lateral and linear structure.

In another embodiment, the control system 200 may include more than one sensor that provides data permitting the processor or other control system component to continually assess the movement of the user and to identify when the user is in a heightened fall risk state. By way of example, the control system may monitor for an uneven or unstable gait, e.g., as a result of leg muscle or joint weakness during any movement event, and may determine that the user is in a heightened fall risk state when such an uneven or unstable gait is detected. In such an embodiment, the control system 200 is configured such that if a predetermined level of instability is detected, the control system 200 causes the pressurization system 150 to inflate one or more bladders in the exoskeleton 120 to provide additional support to person wearing the system 100.

In another embodiment, the exoskeleton 120 includes a plurality of discrete bladders 124 that are not in fluid communication with each other, so that individual ones of the plurality of discrete bladders can be caused to be inflated (by the pressurization system 150) separately/individually under the direction/control of the control system 200. In certain embodiments, one or more individual discrete bladders of the exoskeleton 120 may be inflated selectively according to determinations made by the control system 200 as a function of data received by the one or more sensors 205a, 205b, 205c, etc.

In certain embodiments, the control system 200 is configured to cause inflation of a greater number of individual bladders and/or to inflate one or more bladders to a point of greater air pressure (relative to other bladders) as a result of a determination by the control system (based on sensor data) of a relatively higher degree of instability and/or a degree of a heightened fall risk state.

Generally, the amount of assistive support provided by the system 100 to the wearer can be increased by increasing the inflation air pressure in the bladders and/or increasing the number or location of bladders that are inflated. One or more bladders may be arranged adjacent joints (e.g., hip, knee, etc.) to isolate sections of the body (e.g., leg) and create rigid planes/zones spanning those joints to reinforce/support areas of bodily weakness by the rigid inflated bladder(s), to provide assistive support according to each wearer's needs.

The control system 200 can be configured to initiate the pressurization system's inflation of one or more of the bladders as a user starts to move/walk, and to deflate the bladders during times of rest. In this fashion, the system 100 provides a user with assistive support when the control system 200 objectively determines that there is a need for support by placing the device in a rigid/inflated state (e.g., while moving/walking) and yet the user is not encumbered or discomforted by the system 100 when it is determined not to be needed, by the control system 200 placing the system bladder exoskeleton in a flexible/deflated state (e.g., at during periods of rest when support to prevent a fall is not needed).

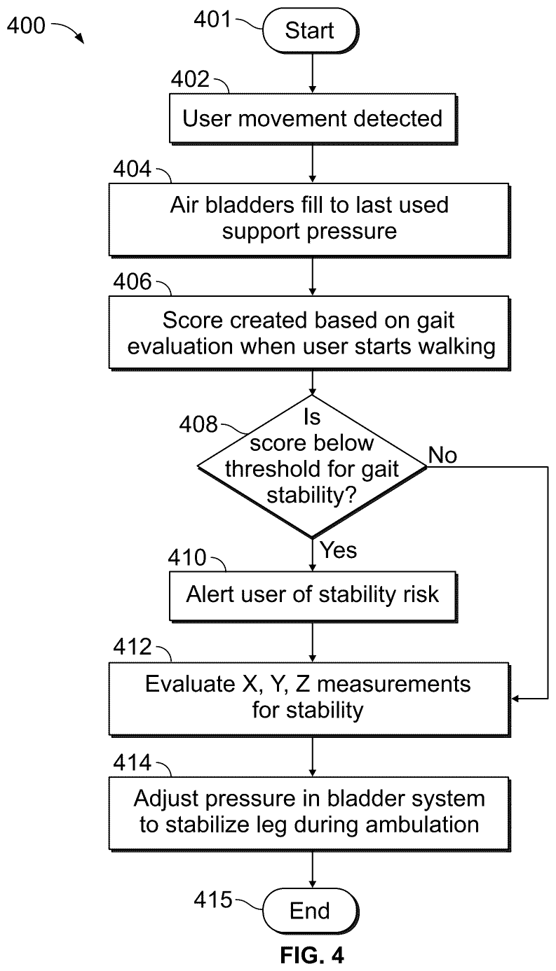

FIG. 4 is a flow diagram 400 illustrating exemplary operation of an exemplary adaptive leg stabilization system 100 to inflate the bladder(s) of the exoskeleton in accordance with the present invention. As shown in FIG. 4, the exemplary method starts with determining whether user movement is detected, as shown at 402. This can be determined by the control system 200, which receives and/or processes data from the sensors 205a, 205b, 205c to determine whether the user is moving/standing/walking, etc. or otherwise in need of support from the system. If so, then the control system 200 sends a control signal to the pressurization system 150 to cause it to inflate one or more of the bladders, as shown at 404. This may involve the control system 200 sending a control signal to cause an actuator to open a valve of a regulator 152, high-pressure air storage tank 158, and/or running a compressor/pump 154 to pressurize gas/air, water, or another fluid and cause the relatively high-pressure fluid to flow to one or more of the bladders to inflate them. In this exemplary embodiment, the control system 200 may control the pressurization system 150 to cause inflation to a predetermined pressure, which may be a default pressure or a previously-used pressure, which may be stored in a memory of the control system 200.

Next, with the bladder(s) of the exoskeleton 120 in a deflated/flexible state, the control system 200 may monitor data received from the sensors 205 during walking, etc., and may process the data to assess the quality of the user's gait, as shown at 406. In certain embodiments, a composite score may be generated according to predetermined logic to reflect the quality (stability/instability/asymmetry) of the user's gait. Any suitable approach to calculating a suitable composite score may be used.

In this example, it is next determined whether the quality of the user's gait is below a certain stability threshold, e.g., by comparing the determined score to a reference score, as shown at 408.

If the user's gait is not below a threshold, then the user is determined to be relatively stable, and the control system 200 continues to monitor sensor data and assess stability, as shown at 412.

If the user's gait is below a threshold, then the control system 200 may alert the user of an instability risk, as shown at 410. For example, the alert may be provided as a noise or notification from the device itself, or by an electronic signal transmitted to a nearby or networked device to cause it to display a message about the state of the gait. In this example, the control system 200 continues to monitor sensor data and assess stability as shown at 412.

Next, the control system 200 sends a control signal to the pressurization system 150 to adjusts the pressure in the bladder(s) (to inflate) to stabilize the joint (e.g., leg during ambulation), as shown at 414, and the exemplary method ends, as shown at 415. By way of example, the control system 200 may adjust pressures and/or adjust the number of compartmentalized support tubes and/or mesh/bladders that are pressurized to provide the support.

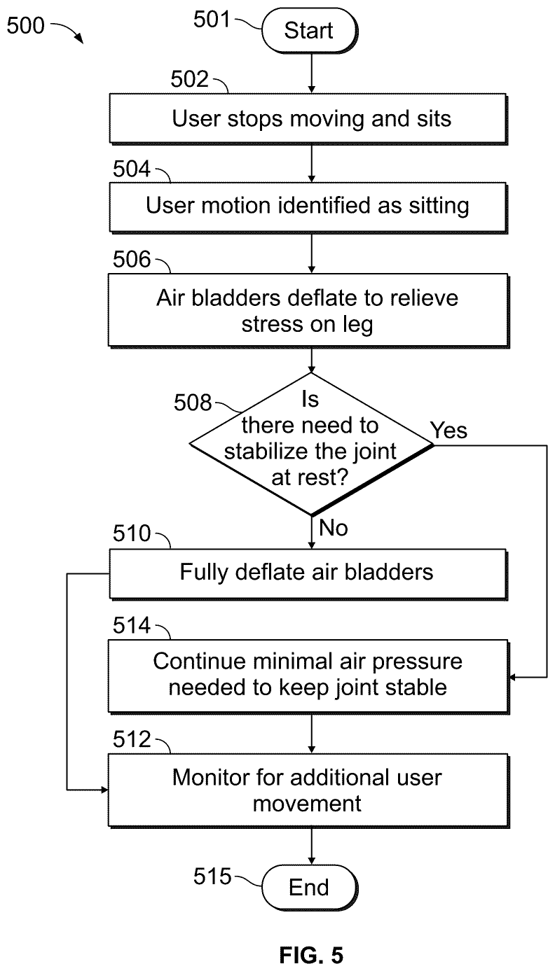

FIG. 5 is a flow diagram 500 illustrating exemplary operation of an exemplary adaptive leg stabilization system 100 to deflate the bladder(s) 124 of the exoskeleton 120 in accordance with the present invention. As shown in FIG. 5, the exemplary bladder deflation method begins with the user stopping movement and/or sitting, as shown at 502. This can be determined by the control system 200, which receives and/or processes data from the sensors 205a, 205b, 205c, e.g., to determine whether the user is no longer moving/standing/walking, etc. or if the system should otherwise deflate the inflated bladder(s) to put the system in the flexible state.

If it is determined at 504 that the user has stopped movement or that the system should otherwise deflate the bladder(s), then the control system 200 sends a control signal to the pressurization system 150 to cause it to deflate one or more of the bladders of the exoskeleton 120, as shown at 506. This may involve causing an actuator to open a valve to bladders to vent them to atmosphere (or otherwise) to deflate them, or to run a pump to cause fluid to flow out of the bladder(s), e.g., to the storage tank 158.

Next, it is determined whether there is a need to stabilize the joint at rest, as shown at 508. Some bodily injuries or deficiencies may require continuous support, whereas some may require lesser support. If not, then the control system 200 sends a suitable control signal to the pressurization system 150 to cause the bladder(s) to deflate (e.g., fully or nearly fully deflate), as shown at 510.

If, however, it is determined at 508 that there is a need to stabilize the joint at rest, then the control system 200 may send a control signal to the pressurization system 150 to cause the bladder(s) to only partially deflate to keep pressure in the bladder(s) sufficient to partially stabilize the joint without the need to support an upright body, as shown at 514.

In either case, the control system 200 then continues to monitor the user for next movement indicating standing/walking, etc. as shown at 512 (which would cause the bladders to be inflated), and the method ends, as shown at 515.

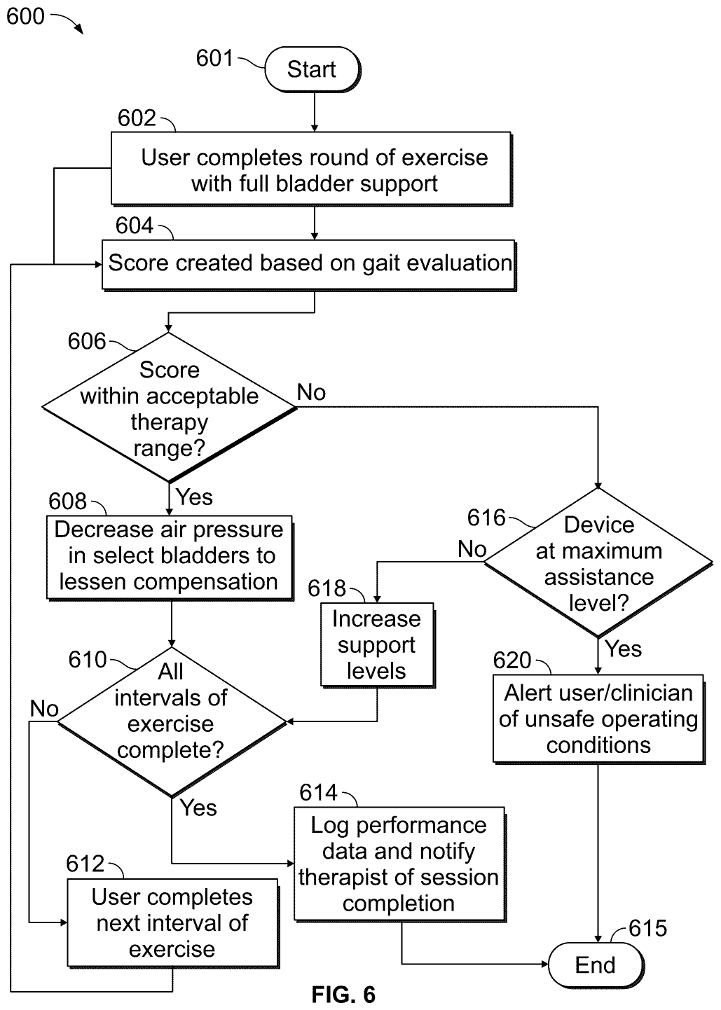

FIG. 6 is a flow diagram 600 illustrating exemplary operation of an exemplary adaptive leg stabilization system 100 to inflate the bladder exoskeleton in an exemplary physical therapy workflow, in accordance with the present invention.

As shown in FIG. 6, an exemplary physical therapy mode or operation involves a method that begins with the user beginning a round of exercise with full support of the bladders, inflated to the determined pressure, as shown at 601 and 602. During the exercise, the control system 200 monitors data received from the sensors 205 during the exercise, and may process the data to assess the quality of the user's gait/stability, as shown at 604. In certain embodiments, a composite score may be generated according to predetermined logic to reflect the quality (stability/instability/asymmetry) of the user's gait/stability during the exercise.

Next, it is determined whether the quality of the user's gait/stability is below a certain stability threshold, e.g., by comparing the determined score to a reference score, as shown at 606. This may be performed by the control system, as referenced above.

If the user's gait/stability is not below a stability threshold, then the user is determined to be relatively stable, and the control system 200 sends a control signal to the pressurization system 150 to partially deflate the bladders to decrease the pressure and thereby to lessen the stabilization assistance provided by the device 100, as shown at 608.

In this illustrative example, it is next determined by the control system 200 whether all intervals of the exercise have been completed, as shown at 610, e.g., based on resent sensor data and data stored or input to a memory of the control system 200. If not, then the user proceeds to complete the next interval of the exercise, as shown at 612, and the method flow returns to 604 where the control system 200 continues to monitor sensor data and assess stability as described above, and the process repeats.

If, however, it is determined by the control system 200 that all intervals of the exercise have been completed at 610, then the method flow continues to 614, and performance data and/or pressure data reflecting assistance by the device is recorded/stored in a memory of the control system 200, and a notification may be sent to a therapist/clinical to notify of the completion of the therapy session, as shown at 614, e.g., via data communication hardware of the control system 200, and the method ends, as shown at 615.

If, however, the user's gait/stability is determined by the control system 200 to be below a stability threshold, at 606, then the control system 200 next determines whether the bladders have been inflated to the maximum pressure or are otherwise in a maximum assistive state, as shown at 616. If not, then the control system 200 increases the level of support provided, e.g., by sending a control signal to increase the bladder pressure and/or number or choice of inflated bladders, as shown at 618, and method flow continues to 610 to determine whether all intervals of the exercise are complete, as described above.

If, however, the control system 200 determines at 616 that the bladders have been inflated to the maximum pressure or are otherwise in a maximum assistive state, then an alert is issued to the user and/or to the clinician to indicate that there are unsafe operating conditions such that the therapy should be stopped, as shown at 620, and the method ends, as shown at 615.

FIG. 7 is a perspective view of an alternative exemplary adaptive leg stabilization system in accordance with an exemplary embodiment of the present invention. FIGS. 8A and 8B are top views of exemplary bladder structures in accordance with the present invention.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An adaptive stabilization system for supporting limbs and joints of a body, the system comprising:
an exoskeleton comprising at least one bladder inflatable to provide structural support at least one of a limb and a joint of the body, said exoskeleton having a flexible state in which said at least one bladder is pressurized to a first pressure and is relatively flexible, and a rigid state in which said at least one bladder is pressurized to a second pressure greater than said first pressure and is relatively rigid;
a pressurization system operable to selectively pressurize and depressurize said at least one bladder; and
a control system comprising:
at least one sensor operable to gather data to in relation to movement activity of a wearer of said exoskeleton; and
a control module operable to process data gathered from said at least one sensor and to provide a control signal to said pressurization system to cause said pressurization system to selectively pressurize and depressurize said at least one bladder as a function of said data.

2. The adaptive stabilization system of claim 1, wherein said at least one bladder is supported on a substrate to fix said at least one bladder in a position for registration with said at least one of a limb and a joint of a human body to provide support when said exoskeleton is in the rigid state.

3. The adaptive stabilization system of claim 1, wherein said exoskeleton is integrated into a wearable article of clothing.

4. The adaptive stabilization system of claim 1, wherein said at least one bladder is provided supported on an internal portion of a wearable article of clothing.

5. The adaptive stabilization system of claim 1, wherein said pressurization system comprises at least one of a compressor and a pump operable to pressurize a fluid.

6. The adaptive stabilization system of claim 5, wherein said pressurization system comprises a reservoir configured to store the fluid.

7. The adaptive stabilization system of claim 1, wherein said pressurization system comprises an actuator operable to selective open and close a valve in fluid communication with said at least one bladder in response to a control signal received from said control module.

8. The adaptive stabilization system of claim 1, wherein said at least one sensor comprises at least one of an accelerometer, a gyroscope, and an altimeter.

9. The adaptive stabilization system of claim 1, wherein said control system comprises a data processor configured to process data received from said at least one sensor.

10. The adaptive stabilization system of claim 1, wherein said control system comprises a data processor configured to process data received from said at least one sensor to determine whether to selectively pressurize or depressurize said at least one bladder.

11. The adaptive stabilization system of claim 1, wherein said control module is configured to send a control signal to pressurize said at least one bladder when said at least one sensor indicates that a wearer is one of standing and walking, and wherein said control module is further configured to send a control signal to depressurize said at least one bladder when said at least one sensor indicates that the wearer is not one of standing and walking.

12. The adaptive stabilization system of claim 1, wherein said control module is configured to send a control signal to pressurize said at least one bladder when an external sensor separate from said exoskeleton indicates that a wearer is one of standing and walking, and wherein said control module is further configured to send a control signal to depressurize said at least one bladder when said external sensor indicates that the wearer is not one of standing and walking.

13. The adaptive stabilization system of claim 1, wherein said control module is configured to process data gathered from the user during walking to determine whether the wearer is in a heightened fall risk state, and to send a control signal to pressurize said at least one bladder when said data indicates that a wearer is in the heightened fall risk state.

14. The adaptive stabilization system of claim 1, wherein said at least one bladder defines first and second pressurizable cuffs positionable to span the joint of the body, and inflatable to secure the exoskeleton to the body.

15. The adaptive stabilization system of claim 1, wherein said exoskeleton comprises a plurality of discrete bladders that are not in fluid communication with each other.

16. The adaptive stabilization system of claim 15, wherein said control system and said pressurization system are configured to permit selective pressurization of each of said plurality of discrete bladders individually.

17. An adaptive stabilization system for supporting limbs and joints of a body, the system comprising:
a substrate configured to be worn on a portion of bodily anatomy in registration with at least one of a limb and a joint of the body;
an exoskeleton supported on said substrate, said exoskeleton comprising at least one bladder fixed to said substrate in a position to span at least a portion of said at least one of the limb and the joint, said at least one bladder being pressurizable to provide structural support said at least one of the limb and the joint, said exoskeleton having a flexible state in which said at least one bladder is pressurized to a first pressure and is relatively flexible, and a rigid state in which said at least one bladder is pressurized to a second pressure greater than said first pressure and is relatively rigid;
a pressurization system supported on said substrate and operable to selectively pressurize and depressurize said at least one bladder; and
a control system supported on said substrate and comprising:
at least one sensor operable to gather data to in relation to movement activity of a wearer of said bladder; and
a control module operable to process data gathered from said at least one sensor and to provide a control signal to said pressurization system to cause said pressurization system to selectively pressurize and depressurize said at least one bladder as a function of said data.

18. The adaptive stabilization system of claim 17, wherein said exoskeleton comprises a plurality of discrete bladders that are not in fluid communication with each other, and wherein said control system and said pressurization system are configured to permit selective pressurization of each of said plurality of discrete bladders individually.

19. The adaptive stabilization system of claim 17, wherein said control module is configured to send a control signal to pressurize said at least one bladder when said at least one sensor indicates that a wearer is one of standing and walking, and wherein said control module is further configured to send a control signal to depressurize said at least one bladder when said at least one sensor indicates that the wearer is not one of standing and walking.

20. The adaptive stabilization system of claim 17, wherein said control module is configured to process data gathered from the wearer during walking to determine whether the wearer is in a heightened fall risk state, and to send a control signal to pressurize said at least one bladder when said data indicates that the wearer is in the heightened fall risk state.

21. An adaptive stabilization system for supporting limbs and joints of a body, the system comprising:
a substrate configured to be worn on a portion of bodily anatomy in registration with at least one of a limb and a joint of the body;
an exoskeleton supported on said substrate, said exoskeleton comprising a plurality of pressurizable bladders that are fixed to said substrate in a position to span at least a portion of said at least one of the limb and the joint and that are not in fluid communication with each other, said plurality of pressurizable bladders being pressurizable to provide structural support said at least one of the limb and the joint, said exoskeleton having a flexible state in which said at least one bladder is pressurized to a first pressure and is relatively flexible, and a rigid state in which said plurality of pressurizable bladders are pressurized to a second pressure greater than said first pressure and is relatively rigid;
a pressurization system supported on said substrate and operable to selectively pressurize and depressurize each of said plurality of pressurizable bladders separately from others of said plurality of pressurizable bladders; and
a control system supported on said substrate and comprising:
at least one sensor operable to gather data to in relation to movement activity of a wearer of said bladder; and
a control module comprising a data processor operable to process data gathered from said at least one sensor and to provide a control signal to said pressurization system to cause said pressurization system to selectively pressurize and depressurize at least one of said plurality of pressurizable bladders as a function of said data;
wherein said control module is configured to send a control signal to pressurize at least one of said plurality of pressurizable bladders when said at least one sensor indicates that a wearer is one of standing and walking, and wherein said control module is further configured to send a control signal to depressurize at least one of said plurality of pressurizable bladders when said at least one sensor indicates that the wearer is not one of standing and walking.
